(19) United States
(12) Patent Application Publication
(10) Pub. No.: US 2008/0081693 A1
(43) Pub. Date: Apr. 3, 2008

(54) GAMING MACHINE AND METHOD OF PLAYING GAME

(75) Inventor: Katsuhiro KIDO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/859,117

(22) Filed: Sep. 21, 2007

(30) Foreign Application Priority Data
Sep. 29, 2006 (JP) 2006-267371

(51) Int. Cl. A63F 13/00

(52) U.S. Cl. 463/31

(57) ABSTRACT

A gaming machine is provided. This gaming machine comprises: a display for displaying a plurality of blocks appearing in a predetermined shape; and a controller for providing a prize when an arrangement shape formed by a combination of blocks displayed on the display matches a predetermined arrangement shape. The plurality of blocks are displayed in a matrix of M by N (here, M and N are natural numbers) on the display. And a display mode of blocks located at predetermined positions among the plurality of blocks displayed on the display is changed during a process until an end of a game.

### CROSS REFERENCE TO RELATED APPLICATIONS

This application is based upon and claims the benefits of priorities from Japanese Patent Application No. 2006-267371 filed on Sep. 29, 2006, the entire contents of which are incorporated herein by reference.

### FIELD OF THE INVENTION

The present invention relates to a gaming machine and a method of playing therewith a game utilizing a predetermined number of blocks displayed on a display. In particular, a display mode of blocks originally displayed in the matrix state is changed during a process until the game ends. And a prize is awarded to a game player based on a shape formed by a combination of blocks in the changed display mode at the end of the game.

### RELATED ART

Conventionally, the slot machine as a kind of gaming machine performs a game as a game medium such as coin is inserted into the slot machine. And the slot machine is configured so that arrays of symbols are displayed variably in a predetermined area of the slot machine and stopped after a predetermined period of time elapses such that the prize is awarded based on the stopped arrays of symbols.

And, it is generally determined whether the combination of symbols to award the prize is won or not based on the game result that a predetermined number of symbols of the same kind (e.g., “CHERRY” or “7”) are aligned on a predetermined pay line. Also, the combination of stopped symbols determines the prized irrespective of the pay line.

A slot machine which displays 15 symbols in total in a matrix of 3 by 5 with video reels or mechanical reels is disclosed in U.S. Pat. Nos. 6,093,102 and 6,960,133. In the slot machine, once the game is started, each array of symbols are displayed variably in a sequent manner and stopped after a predetermined period of time such that three symbols in each array are displayed statically. And the prize is awarded when the combination of symbols is displayed statically as the number of symbols of the same kind is more than a predetermined number.

Here, in the conventional slot machine, even though it is determined whether the combination corresponding to the prize is won or not according to the pay line, or it is determined whether the combination corresponding to the prize is won or not irrespective of the pay line, it is common that the game proceeds by displaying the symbols in a predetermined plurality of display areas.

### SUMMARY OF THE INVENTION

According to the present invention, it is possible to notify a game player of a content of a prize by a gradually changing arrangement shape formed by a combination of blocks as the game proceeds such that it is possible to provide a new type of game which does not rely on displayed symbols. And it is also possible to provide a gaming machine and a method of playing therewith a game having a variety of notification of the game results.

A gaming machine is provided. This gaming machine comprises: a display for displaying a plurality of blocks appearing in a predetermined shape; and a controller for providing a prize when an arrangement shape formed by a combination of blocks displayed on the display matches a predetermined arrangement shape. The plurality of blocks are displayed in a matrix of M by N (here, M and N are natural numbers) on the display. And a display mode of blocks located at predetermined positions among the plurality of blocks displayed on the display is changed during a process until an end of a game.

A method of playing a game with the gaming machine is also provided. The method comprises: displaying blocks in a matrix of M by N (here, M and N are natural numbers); changing a display mode of blocks located at predetermined positions among the blocks in the matrix displayed on the display during a process until the game ends; and providing a prize when an arrangement shape formed by a combination of blocks matches a predetermined arrangement shape.

Further features of the present invention, its nature, and various advantages will be more apparent from the accompanying drawings and the following description of the preferred embodiment.

### BRIEF DESCRIPTION OF THE DRAWINGS

FIG. 1 illustrates processing in which a block arrangement showing a shape of a house, which is displayed on a lower display, is formed according to Embodiment 1.

FIG. 2 is a perspective view of a gaming machine according to Embodiment 1.

FIG. 3 illustrates processing in which a block arrangement showing a shape of a vehicle, which is displayed on the lower display, is formed according to Embodiment 1.

FIG. 4 is a view showing a block arrangement having a shape of “B” that suggests a bonus game wherein the block arrangement is displayed on the lower display according to Embodiment 1.

FIG. 5 is a view showing a block arrangement having a shape of a skull that suggests a blank or lose wherein the block arrangement is displayed on the lower display according to Embodiment 1.

FIG. 6 is a view showing an example of a block arrangement in which a display color of blocks is changed after the block arrangement is formed into a shape of the house during the processing as shown in FIG. 1.

FIG. 7 is a view showing an example of a block arrangement in which a display color of blocks is changed after the block arrangement is formed into a shape of the vehicle during the processing as shown in FIG. 3.

FIG. 8 is a view showing a payout table of the gaming machine according to Embodiment 1.

FIG. 9 is a block diagram showing schematically a control system of the gaming machine according to Embodiment 1.

FIG. 10 shows a flowchart of a main control process program in the gaming machine according to Embodiment 1.

FIG. 11 shows a flowchart of a main game process program in the gaming machine according to Embodiment 1.

FIG. 12 illustrates processing in which a block arrangement showing a shape of a house, which is displayed on the lower display, is formed according to Embodiment 2.

FIG. 13 is a view showing a block arrangement in which the display mode of blocks in the leftmost column is changed.

FIG. 14 is a view showing a block arrangement in which the display mode of blocks in the left three columns is changed.

FIG. 15 is a view showing a block arrangement in which the display mode of blocks in the left five columns is changed.

FIG. 16 is a view showing a block arrangement in which the display mode of blocks in the left eight columns is changed.

FIG. 17 is a view showing a block arrangement in which the display mode of blocks in the whole matrix is changed.

FIG. 18 is a view showing a block arrangement in which the display mode of blocks on the outmost shell is changed.

FIG. 19 is a view showing a block arrangement in which the display mode of blocks on the outer two shells is changed.

FIG. 20 is a view showing a block arrangement in which the display mode of blocks on the outer three shells is changed.

FIG. 21 is a view showing a block arrangement in which the display mode of core blocks in the center portion is changed.

FIG. 22 is a view showing a block arrangement in which the display mode of extended core blocks in the center portion is changed.

FIG. 23 is a view showing a block arrangement in which the display mode of further extended core blocks in the center portion is changed.

FIG. 24 is a view showing a block arrangement in which the display mode of the blocks on only the outmost shell is not changed.

FIG. 25 is a view showing a block arrangement having a shape of a yacht displayed on the lower display.

FIG. 26 is a view showing another payout table of the gaming machine according to another example.

### DETAILED DESCRIPTION OF THE PREFERRED EMBODIMENT

Hereinafter, a gaming machine of the present invention is described in detail according to Embodiments 1 and 2 with reference to the drawings. The gaming machine according to Embodiments 1 and 2 has an image display device such as a liquid crystal display and is configured so as to perform a game by displaying a number of blocks which appear square on the image display device.

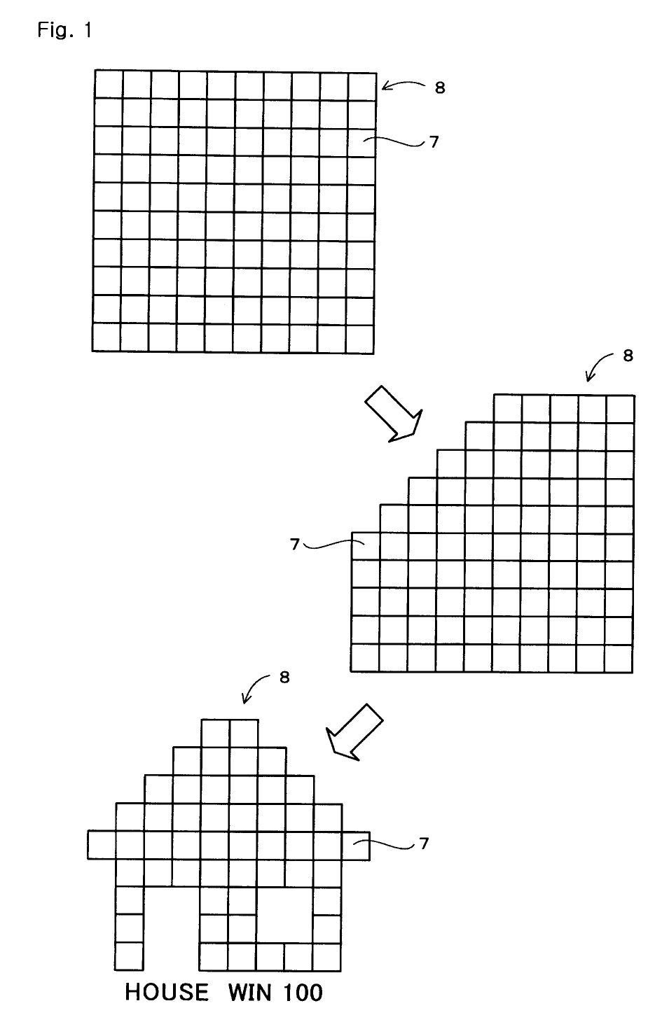

The gaming machine relating to the present invention displays one hundred blocks 7 in a matrix of 10×10 on the display at the beginning as shown in FIG. 1 and gradually eliminates blocks 7 at predetermined positions among the originally-displayed blocks 7 towards the end of the game. The gaming machine is characterized by providing a prize when an appearing pattern made of a combination of remaining blocks 7 which have not eliminated matches a predetermined pattern (a pattern of a house as shown in FIG. 1).

### Embodiment 1

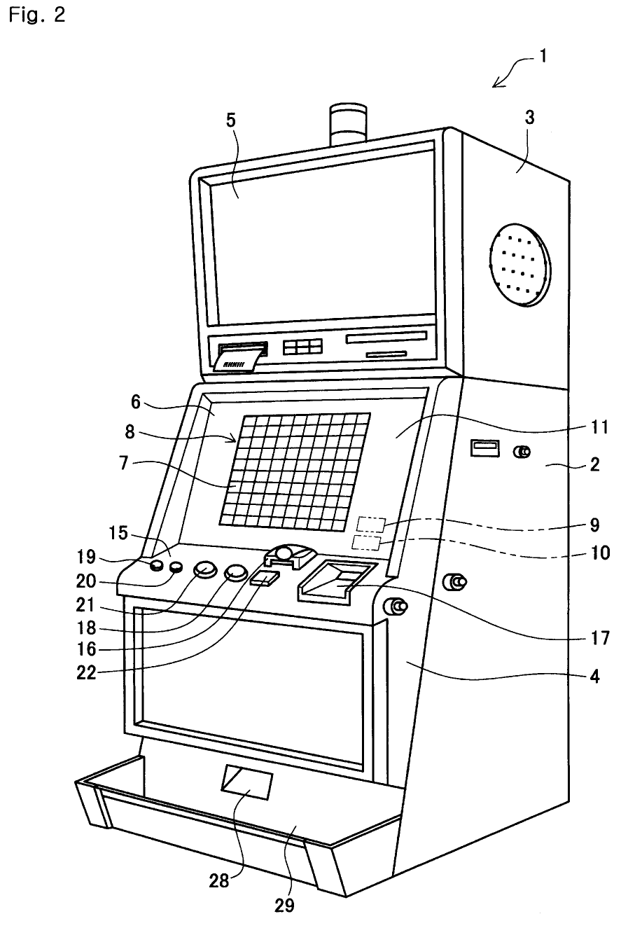

First, a general configuration of a gaming machine 1 according to Embodiment 1 is described with reference to FIG. 2. FIG. 2 is an external perspective view of the gaming machine 1 according to the Embodiment 1.

The gaming machine 1 according to the Embodiment 1 is provided with a cabinet 2, a top box 3 placed on the top of the cabinet 2, and a main door 4 provided on the front face of the cabinet 2.

An upper display 5 is provided on the front face of the top box 3. The upper display 5 is constituted of a publicly known liquid crystal display so as to display a game method, a payout table, and the like.

On the other hand, a lower display 6 is provided on the front face of the main door 4. The lower display 6 is constituted of a publicly known liquid crystal display so as to display a set of blocks 8 in a matrix of 10 times 10 [10×10] (the total number of blocks is 100). Some blocks 7 that are arranged at predetermined positions in a block arrangement 8 composed of a set of blocks 7 are gradually brought into a non-displayed state after the game is started. Then, a predetermined prize is paid out to a game player based on the pattern made of the block arrangement 8 composed of a combination of blocks 7 which remain without entering into the non-displayed state after a predetermined time of time elapses. Here, the number of blocks 7 displayed at the game start is not limited to 100 yielded from the matrix of 10×10, but may be MN yielded from the matrix of M×N (M and N are natural numbers). For example, the number of blocks may be 25 from a matrix of 5×5 or 200 from a matrix of 10×20. Further, block 7 which appears square may appear rectangular or rhombic.

A touch panel 11 is provided on the front face of the lower display 6, and the game player can operate the touch panel 11 to input various kinds of instructions.

Further, a credit number display part 9 and a payout number display part 10 are provided on the lower display 6. The credit number display part 9 shows the number of credits currently owned by the game player. The payout number display part 10 exhibits, as a payout number, the amount of the prize to be paid out when the pattern of the block arrangement 8 composed of a set of blocks 7 matches a predetermined pattern.

Below the lower display 6, a control panel 15 in which a plurality of buttons allowing the game player to input instructions concerning the progress of the game are arranged, a coin receiving opening 16 which accepts coins serving as game media into the cabinet 2, and a bill insertion slot 17 are provided.

The control panel 15 is provided with a start button 18, a change button 19, a CASHOUT button 20, a 1-BET button 21, and a MAX BET button 22. The start button 18 is an operating means for inputting an instruction to start the change of the display mode of the blocks 7. The change button 19 is an operating means used for asking a clerk in an amusement center (or arcade) to exchange money. The CASHOUT button 20 is an operating means for inputting an instruction to pay out coins (one credit is equivalent to one coin) from a coin payout opening 28 to a coin tray 29 in accordance with the number of credits owned by the game player, or an instruction to discharge a ticket with a bar-code.

The 1-BET button 21 is an operating means for receiving an instruction to bet one credit on a game from among the credits owned by the game player. The MAX BET button 22 is an operating means for receiving an instruction to bet on a game the maximum number of credits (five (5) credits in the Embodiment 1) which can be bet on a single game from among the credits owned by the game player. It is also possible to provide various kinds of BET buttons such as a 3-BET button.

In the gaming machine 1 according to the Embodiment 1, coins, bills or electronic valuable information (credit) equivalent thereto is used as game media. However, the game media applicable to the present invention are not limited to the aforementioned media, but medals, tokens, electronic money and tickets, for example, may also be utilized.

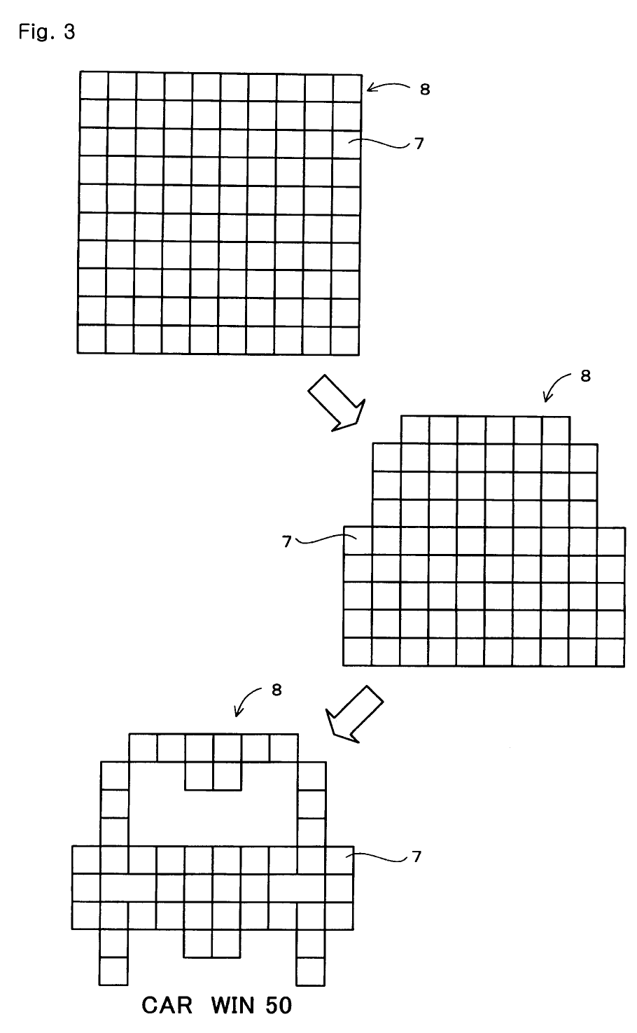

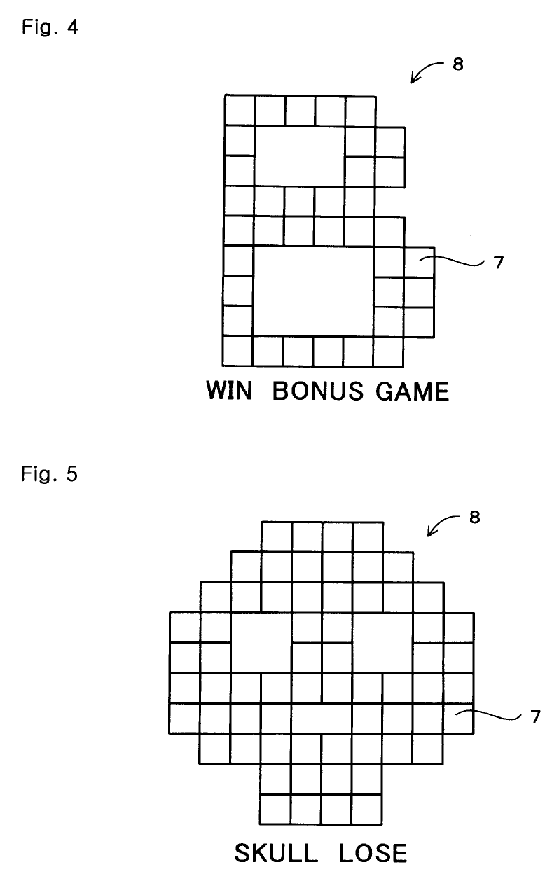

Then, the block arrangement 8 displayed on the lower display 6 during the game is described with reference to FIGS. 1, and 3 to 5. FIG. 3 is a drawing illustrating a process in which the block arrangement 8 showing a pattern of a vehicle is being formed on the lower display 6 according to the Embodiment 1. FIG. 4 is a drawing illustrating a block arrangement 8 showing a pattern of “B” which suggests a bonus game to be displayed on the lower display 6 according to the Embodiment 1. FIG. 5 is a drawing illustrating a block arrangement 8 showing a pattern of a skull which suggests a blank or a losing pattern to be displayed on the lower display 6 according to the Embodiment 1.

As shown in FIGS. 1 and 3, the block arrangement 8 which is displayed on the lower display 6 according to the Embodiment 1 is constituted of blocks 7 having been originally arranged in the matrix of 10×10 in the maximum size. If the game is started, some of the blocks 7 which constitute the original block arrangement 8 gradually become in a non-displayed state. Then, when the block arrangement 8 is formed in a predetermined pattern, the change of the displayed pattern composed of the blocks 7 is stopped such that a prize is paid out according to the resulted pattern.

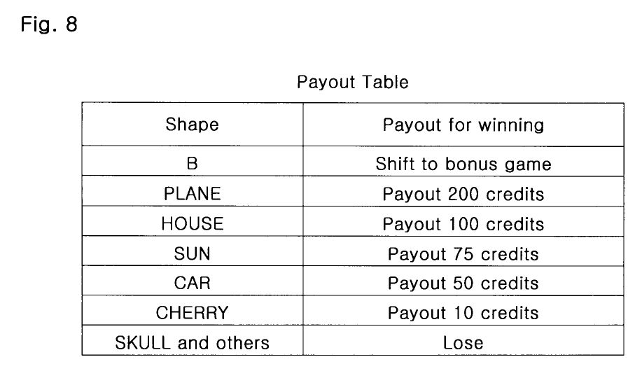

FIG. 8 is a drawing showing the payout table of the gaming machine 1 according to the Embodiment 1. When the resultant pattern of the block arrangement 8 composed of the combination of blocks 7 matches the pattern of the alphabet “B” (refer to FIG. 4), for example, the bonus game as a prize is performed as shown in FIG. 8 right after a base game ends. When the resultant pattern of the block arrangement 8 matches the pattern of an airplane, 200 credits are paid out as a prize. When the resultant pattern of the block arrangement 8 matches the pattern of a house, 100 credits are paid out as a prize. When the resultant pattern of the block arrangement 8 matches the pattern of the sun, 75 credits are paid out as a prize. When the resultant pattern of the block arrangement 8 matches the pattern of a vehicle, 50 credits are paid out as a prize. When the resultant pattern of the block arrangement 8 matches the pattern of a cherry, 10 credits are paid out as a prize. When the resultant pattern of the block arrangement 8 matches the pattern of the skull (refer to FIG. 5) or any other patterns than the aforementioned patterns, the game result is a blank (or lose) such that no prize (or no payout amount) is provided.

Among the above-mentioned patterns made of the block arrangement 8, in particular, the pattern that triggers to provide the prize of the bonus game is the pattern of “B”, which is the initial letter of “BONUS GAME”, thereby suggesting the meaning of the prize.

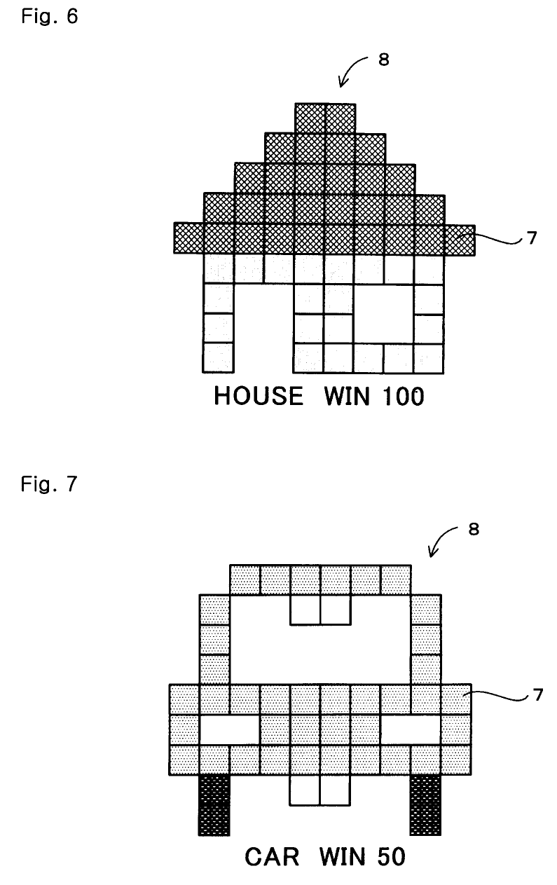

After the block arrangement 8 displayed on the lower display 6 shows a predetermined pattern, the display color of some of the blocks located at the predetermined positions may be changed in order to make the pattern more easily recognizable to the game player. For example, FIG. 6 shows the block arrangement 8 in a state where the display color of some of the blocks 7 located at the roof portion of a house is changed into grey, and the display color of the other of the blocks 7 located at the outer wall portion of the house is changed into yellow, after the block arrangement 8 shows the pattern of the house in accordance with the process shown in FIG. 1. If the display color of the blocks 7 is changed as shown in FIG. 6, the pattern of the block arrangement 8 composed of the combination of the blocks 7 can be more clearly recognized as a house.

FIG. 7 shows a block arrangement 8 in a state where the display color of some of the blocks 7 located at a body portion of a vehicle is changed into red, and the display color of some of the blocks 7 located at the tire portion of the vehicle is changed into black, after the block arrangement 8 shows the pattern of the vehicle according to the process shown in FIG. 2. If the display colors of those of the blocks 7 are changed as shown in FIG. 7, the pattern of the block arrangement 8 composed of the combination of blocks 7 can be more clearly recognized as a vehicle.

Next, the game progress procedure of the gaming machine 1 is described concretely according to the Embodiment 1. First, when the start button 18 is pressed after the end of bet acceptance processing, internal lottery processing which determines the content of the prize is performed. Then, some at predetermined positions of the blocks 7 in the matrix of 10×10 displayed on the lower display 6 gradually become in a non-displayed state. As a result, a pattern according to the content of the prize determined by the lottery is formed by the combination of blocks 7 displayed on the lower display 6 so as to pay out the prize.

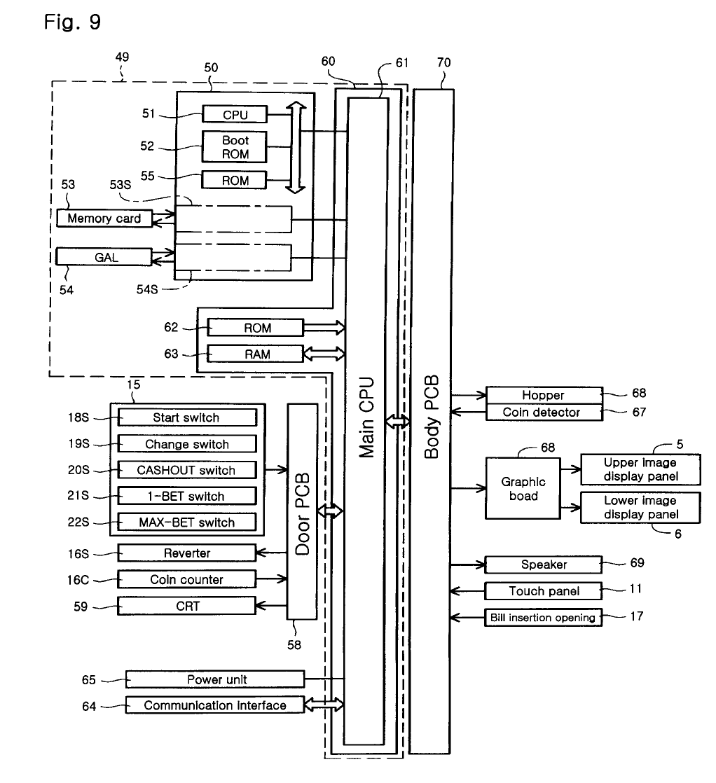

Next, the configuration of the control system of the gaming machine 1 according to the Embodiment 1 is described with reference to FIG. 9. FIG. 9 is a block diagram schematically illustrating the control system of the gaming machine 1 according to the Embodiment 1.

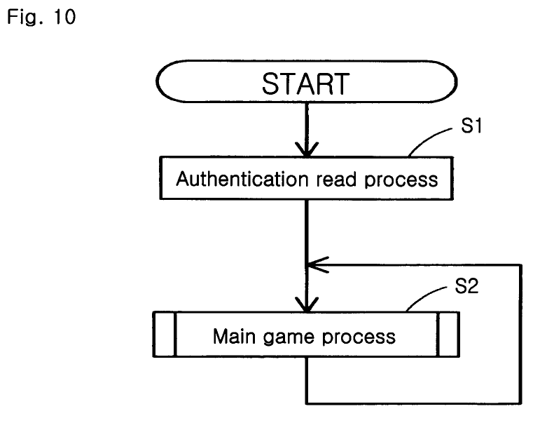

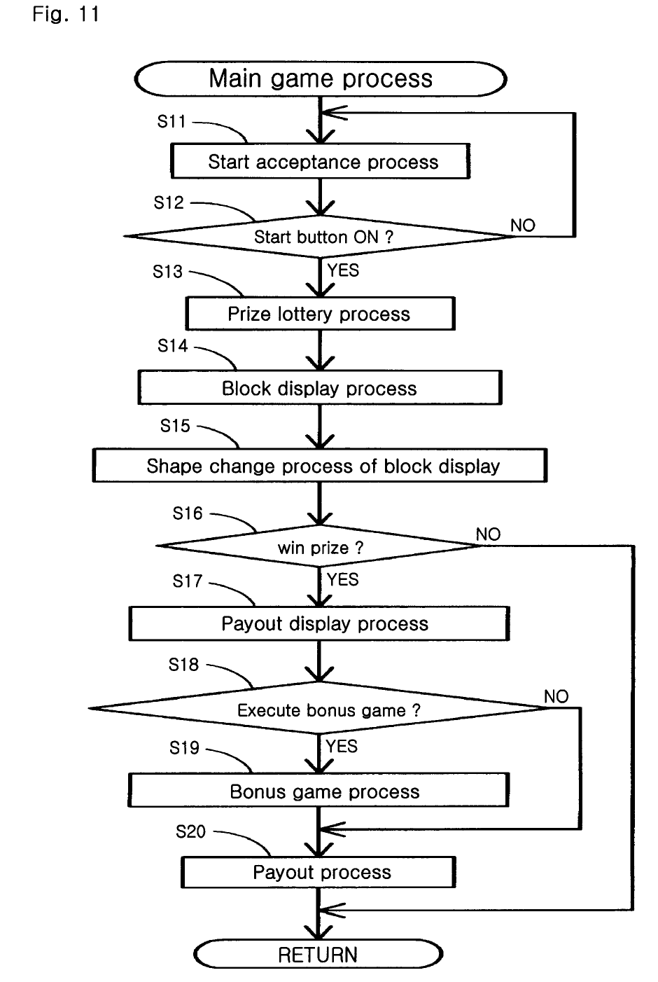

As shown in FIG. 9, the control system of the gaming machine 1 is basically constituted of a mother board 60 and a gaming board 50. A controller 49 which executes a control program (FIGS. 10 and 11) to be mentioned later is constituted of the mother board 60 and the gaming board 50.

First, the gaming board 50 is described. The gaming board 50 is provided with a CPU 51, a ROM 55, and a boot ROM 52 connected with each other by an internal bus, a card slot 53S corresponding to a memory card 53, and an IC socket 54S corresponding to a GAL (Generic Array Logic) 54.

The memory card 53 comprises a non-volatile memory and is a recording medium which stores a game program and a game system program (hereinafter referred to as a game program and the like). The game program recorded on the memory card 53 includes a lottery program. This lottery program is a program for determining the prize provided in the this game out of the prizes shown in FIG. 8.

The memory card 53 contains a prize lottery table for selecting by lottery the content of the prize provided in the present game. Here, the prize lottery table is a table for correlating a predetermined random number value range with the seven kinds of prizes as shown in FIG. 8. The prize provided to the game player is determined based on a sampled random number value and the prize lottery table.

Next, the mother board 60 is described. The mother board 60 is constituted of a general-purpose mother board (printed circuit board on which the basic components of a computer are mounted) which is commercially available and is provided with a main CPU 61, a ROM 62, a RAM 63, and a communication interface 64.

The ROM 62 is constituted of a memory device such as a flash memory and stores permanent data such as programs, e.g., BIOS performed by the main CPU 61. When the main CPU 61 executes the BIOS, predetermined peripheral devices are initialized and the loading processing of the game program and the like currently stored in the memory card 53 is started via the gaming board 50.

The RAM 63 stores data and programs used when the main CPU 61 operates. The RAM 63 can store various programs such as an authentication program and a game program read via the gaming board 50 and a variety of information such as the number of credits which the game player currently owns.

The communication interface 64 is a communication device for communicating with a server installed in the amusement center via a communication line.

A main body PCB 70 and a door PCB 58 to be described later are connected to the mother board 60 via USBs. Further, a power supply unit 65 is connected to the mother board 60. When the electric power is supplied from the power supply unit 65 to the mother board 60, the main CPU 61 of the mother board 60 is activated. Moreover, electric power is supplied to the gaming board 50 via a PCI bus to activate the CPU 51.

A hopper 66, a coin detector 67, a graphics board 68, a speaker 69, a touch panel 11, a bill insertion slot 17, and the like are connected to the main body PCB 70.

The graphics board 68 controls the image display on the upper display 5 and the lower display 6 based on control signals transmitted from the main CPU 61. For example, the graphic board 68 causes the payout table and a help screen to be displayed on the upper display 5 and causes at most 100 blocks in a matrix of 10×10 to be displayed on the lower display 6.

On the other hand, the control panel 15, a reverter 16S, a coin counter 16C, and a cold cathode tube (CRT) 59 are connected to the door PCB 58. The control panel 15 is provided with a start switch 18S corresponding to the start button 18, a change switch 19S corresponding to the change button 19, a CASHOUT switch 20S corresponding to the CASHOUT button 20, a 1-BET switch 21S corresponding to the 1-BET button 21, and a MAX BET switch 22S corresponding to the MAX BET button 22. Each switch outputs an input signal to the main CPU 61 when the corresponding button is operated by the game player.

Then, a main control program executed by the gaming machine 1 according to the Embodiment 1 is now described in detail with reference to the drawings. FIG. 10 shows a flowchart of the main control program.

In the gaming machine 1, it is assumed that the memory card 53 is already inserted into the card slot 53S of the gaming board 50, and the GAL 54 is attached to the IC socket 54S.

First, when an electric power switch is turned on (application of power) in the power supply unit 65, the mother board 60 and the gaming board 50 start, and an authentication read process of Step (herein after abbreviated as “S”) 1 is executed. In this authentication read process, the mother board 60 and the gaming board 50 perform separate processes in parallel, respectively.

That is, in the gaming board 50, the CPU 51 reads a preliminary authentication program stored in the boot ROM 52. According to the read preliminary authentication program, the CPU 51 in advance performs a preliminary authentication process for verifying and proving that the authentication program has not been altered before loading the authentication program into the mother board 60.

In the mother board 60, on the other hand, the main CPU 61 executes the BIOS stored in the ROM 62 to decompress data compressed so as to be incorporated into the BIOS such that the developed data is stored in the RAM 63. The main CPU 61 executes the BIOS decompressed into the RAM 63 such that various peripheral devices are diagnosed and initialized.

Then, the main CPU 61 reads the authentication program stored in the ROM 55 and performs the authentication process for verifying and proving that the game program stored in the memory card 53 inserted into the card slot 53S has not been altered. After this authentication process is completed normally, the main CPU 61 writes the (authenticated) game program and the like, used as the authentication objective into the RAM 63. Then, the main CPU 61 executes a loading process for reading payout rate setting data stored in the GAL 54 via the gaming board 50 and writes the thus-read payout rate setting data into the RAM 63.

After performing the processes mentioned above, the main CPU 61 ends the authentication read process.

Subsequently, in S2, the main CPU 61 sequentially reads from the RAM 63 the game program and the like authenticated in the authentication read process of S1 and executes the read program to perform a main game process. By executing this main game process, the game in the gaming machine 1 according to the Embodiment 1 is performed. While the power is being supplied to the gaming machine 1, the main game process is carried out repeatedly.

Next, a sub-process of the above-mentioned main game process S2 is explained with reference to FIG. 11. FIG. 11 shows a flowchart of the main game process program with the gaming machine 1 according to the Embodiment 1. Here, each of the following programs shown in the flowchart of FIG. 11 is stored in the memory card 53, is decompressed to the RAM 63 which is provided to the gaming machine 1, and is executed by the main CPU 61.

First, as shown in FIG. 11, the main CPU 61 performs a start acceptance process in S11 for setting up the amount of coin insertion, the number of bets, and the like after performing predetermined the initial setting. In this stage, a process of clearing the data (for example, counter data of the number of paid-out coins and the like) of the items set in a predetermined data area is performed in the initialization process. Further, in the start acceptance process, the game player performs a bet operation for inputting the number of bet coins (bet number) in this game such that the bet number is set to one of 1 BET to 5 BETs by means of coin insertion, the 1-BET button 21, and the MAX BET button 22.

Then, in S12, the main CPU 61 determines whether or not the start button 18 is operated. It is determined whether or not the start button 18 is operated based on the result of determining whether or not an input signal has been received from the start switch 18S.

When the game player does not operate the start button 18 (S12: NO), the program shifts back to the start acceptance process (S11). In such an event, it is possible to conduct an operation to change the bet number. On the other hand, when the start button 18 is operated to input an instruction (S12: YES), the number of bet coins based on the operation of the 1-BET button 21 or the MAX BET button 22 is subtracted from the number of credits owned by the player, and the resultant number is stored in the RAM 63 as bet information.

Thereafter in S13, the main CPU 61 executes a prize lottery process for selecting the content of the prize provided in this game by lottery. More specifically, the main CPU 61 samples a random number value out of a predetermined random number value range by executing a random number generation program included in the lottery program stored in the RAM 63 and determines the content of the prize out of the seven kinds of prizes as shown in FIG. 8 in accordance with the sampled random number value and the prize lottery table.

Then in S14, the main CPU 61 causes the lower display 6 to display the block arrangement 8 which shows 100 blocks in a matrix of 10×10 (100 pieces in total). In the following S15, some of the blocks 7 located at the predetermined positions from among the blocks 7 displayed in S14 are gradually brought into a non-displayed state. All those blocks 7 located at the predetermined positions are eliminated (or erased) from the display so that the block arrangement 8 shows a pattern corresponding to the content of the prize selected by lottery in S13 (for example, in the case that the payout of 200 credits is determined as the prize).

In S15, the relevant those blocks 7 may be made into the non-displayed state at once instead of gradually making the relevant those blocks 7 into the non-display state. Further, an effect image may be displayed in which a character (for example, a worm) appears and eats the relevant those blocks 7 so as to make them gradually into a non-displayed state.

Subsequently, in S16, the main CPU 61 determines whether or not any one of the prizes is to be provided in this game based on the lottery result in S13.

When the payout of the prize is determined (S16: YES), the program shifts to S17. On the other hand, when it is determined that no payout is conducted if no prize is won (S16: NO), the main game process is terminated. Here, when another game is consecutively started, the processes from S1 are performed again.

In S17, the main CPU 61 notifies the game player of the content of the prize by displaying an image corresponding to the prize on the lower display 6 based on the combination of blocks won in the lottery process. In FIG. 1, for example, the shape of the house is formed by the combination of blocks 7 and the characters of “WIN 100”, which notifies the player of the payout of 100 credits as a prize, are displayed.

Then, in S18, it is determined whether or not the bonus game is to be performed based on the lottery result in S13. As a result, when it is determined to perform the bonus game (S18: YES), the program shifts to a bonus game process (S19). Although various kinds of modes can be considered as the bonus game, it is assumed here that a free game is the bonus game for the convenience of the explanation. Here, the free game is a game in which the same game as the base game may be repeated a predetermined number of times without conducting a BET operation. In the bonus game process in S19, display and non-display controls of the blocks 7 are repeated for a predetermined number of times and the prizes won during the above repeated processes are paid out to the game player cumulatively in the payout process in S20 to be mentioned later. Here, the condition to trigger the shift to the bonus game may be undisclosed as a mystery so as to be satisfied unexpectedly, and various kinds of conditions may be set. As the lottery table utilized in the free game, a lottery table designed so that the payout amount is greater than that of the base game may also be used. On the other hand, when it is determined that the bonus game is not to be performed (S18: NO), the program shifts to S20.

In S20, the main CPU 61 causes the prize to be paid out to the game player based on the pattern formed by the combination of blocks 7 displayed on the lower display 6. In this case, it is also possible to pay out the corresponding number of coins (one credit is equivalent to one coin) to the number of credits by pressing the CASHOUT button 20, or to pay out the same amount by the ticket with the bar code.

As explained in the above, in the gaming machine 1 according to the Embodiment 1, the number of bets in this game is input by the game player's operation of the 1-BET button 21 or the MAX BET button 22 at the beginning of the game and set to any one of 1 BET to 5 BETs (S11). Then, the content of the prize provided in this game is selected by lottery (S13). In the following processing, 100 blocks 7 in a matrix of 10×10 are displayed on the lower display 6 (S14), some of the blocks 7 displayed at the predetermined positions are gradually made into a non-displayed state (S15) so as to form a pattern of the block arrangement 8 corresponding to the content of the prize to be awarded during the process until the end of the game. And the prize is provided to the game player in accordance with the pattern of the combination of the blocks 7 displayed at the time of the game end (S20). Thus, it is possible to provide the game player with a new type of game which does not rely on the symbols displayed on the display such that a wider variety of notification of the game result may be obtained.

Moreover, since, in particular, the pattern utilized for the prize of performing the bonus game has the shape of “B”, which is the initial letter of “BONUS GAME”, among the patterns formed by the combinations of the blocks 7, such that the pattern which suggests the content of the prize enables the game player to recognize whether or not the prize for the bonus game is won in this game by just looking at the pattern of the blocks 7. Further, the feeling of anticipation of the game player for the change of the pattern of the blocks 7 can be further enhanced.

Since the display color of the blocks 7 arranged in the predetermined positions is changed in the process lasting until the game is completed, the pattern of the set of blocks 8 formed by the combination of the blocks 7 can be recognized more clearly.

### Embodiment 2

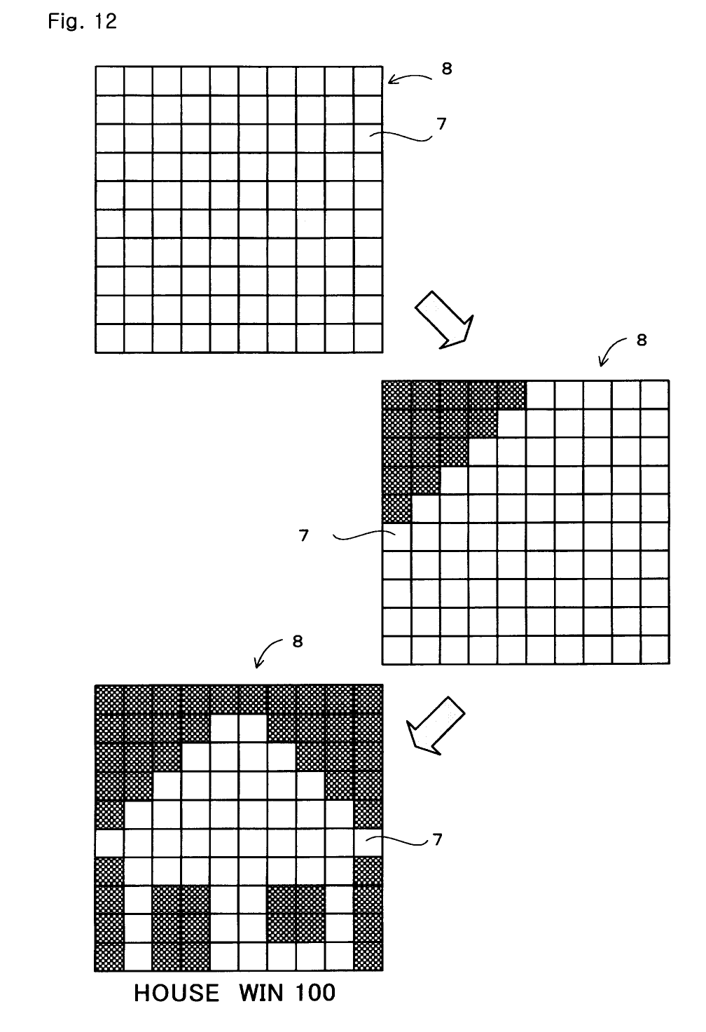

Next, the gaming machine according to Embodiment 2 is described with reference to FIG. 12. In the following description, the same reference numerals as those of the gaming machine 1 according to the Embodiment 1 of the above FIGS. 1 through 11 show the same or corresponding parts as those of the gaming machine 1 and the like according to the Embodiment 1.

The gaming machine according to the Embodiment 2 has a configuration substantially identical to that of the gaming machine 1 according to the Embodiment 1. Each kind of control processes is also substantially the same as those of the gaming machine 1 according to the Embodiment 1.

However, the gaming machine 1 according to the Embodiment 1 awards the prize based on the pattern of the remaining blocked displayed on the lower display (S20) as the other blocks 7 located at the predetermined positions among the combination of blocks displayed in the matrix on the lower display 6 during the processes until the game is completed (S16) whereas the gaming machine 1 according to the Embodiment 2 changes the display color of some blocks 7 located at a predetermined positions from among the displayed blocks 7 in the matrix such that the prized is awarded to the game player based on a color pattern of the blocks 7 after the color changed. In this point, the gaming machine 1 according to the Embodiment 2 differs from that according to the Embodiment 1.

In the following, the block arrangement 8 which is displayed on the lower display 6 during the process of the game played on the gaming machine 1 according to the Embodiment 2 is described with reference to FIG. 12. FIG. 12 shows a process in which the shape of home made of the block arrangement 8 is displayed on the lower display 6 according to the Embodiment 2.

As shown in FIG. 12, the block arrangement 8 displayed on the lower display 6 according to the Embodiment 2 is constituted of at most 100 blocks 7 displayed in a matrix form of 10×10. When the game is started, the display color of some blocks 7 which constitute the block arrangement 8 is gradually changed into black. Then, when the combination of remaining blocks 7 shows a predetermined pattern in the original display color, the change of the display color of the blocks 7 is stopped and the prize corresponding to the pattern is paid out.

Conversely, when the display color of the combination of blocks 7 may be changed so as to show a predetermined pattern, the display color change of the blocks 7 may be stopped and the prize according to the shown pattern may be paid out. Also, when a combination of two kinds of blocks 7 which have a changed display color and an original display color, respectively, forms a predetermined shape, the change of the display color of the blocks 7 may be stopped and the prize according to the shown pattern may be paid out.

Next, the game progress procedure of the gaming machine 1 according to the Embodiment 2 is described concretely. First, when a start button 18 is pressed after bet acceptance is completed, an internal lottery process for determining the content of the prize is performed. Thereafter, the display color of the blocks 7 of the prescribed positions is gradually changed into black from among blocks 7 in the matrix of 10×10 displayed on the lower display 6. The pattern corresponding to the content of the prize determined by lottery is formed by the combination of blocks 7 having the unchanged display color among the blocks 7 displayed on the lower display 6 and the prize is awarded.

As explained in the above, in the gaming machine 1 according to the Embodiment 1, the number of bets in this game is input by the game player's operation of the 1-BET button 21 or the MAX BET button 22 at the beginning of the game and set to any one of 1 BET to 5 BETs. Then, the content of the prize provided in this game is selected by lottery. In the following processing, 100 blocks 7 in a matrix of 10×10 are displayed on the lower display 6, the display mode of some of the blocks 7 displayed at the predetermined positions is gradually changed so as to form a pattern of the block arrangement 8 corresponding to the content of the prize to be awarded during the process until the end of the game. And the prize is provided to the game player in accordance with the pattern of the combination of the blocks 7 displayed at the time of the game end. Thus, it is possible to provide the game player with a new type of game which does not rely on the symbols displayed on the display such that a wider variety of notification of the game result may be obtained.

It is needless to say that the present invention is not limited to the aforementioned embodiments such that it is possible to make various kinds of improvements and modifications within the scope without departing from the spirit of the present invention.

For example, the Embodiments 1 and 2 disclose that 100 blocks 7 in the matrix of 10×10 (100 blocks in total) are displayed on the lower display 6 when the game is started, and that, among the blocks 7 displayed thereafter, the display mode of the blocks 7 located at the predetermined positions is changed. However, the number of blocks 7 displayed at the time of the game start is not limited to 100 yielded from the matrix of 10×10, but just needs to satisfy the conditions of M×N pieces (M and N are natural numbers), for example, may be 5×5 or 10×20.

As an example of changing the display mode of the blocks 7, the blocks 7 are shifted into a non-display state in the Embodiment 1, or the display color of the blocks 7 is changed in the Embodiment 2. However, other configurations to change the display modes may also be conceivable. For example, the pattern of combination of the blocks 7 may be changed into a form corresponding to the prize to be assigned by newly adding blocks 7 and displaying the resultant pattern on the lower display 6. Further, the pattern of the combination of the blocks 7 may be changed into a pattern corresponding to the prize to be provided by changing the arrangement of the blocks 7 being currently displayed.

The display mode of the blocks 7 may be changed all at once instead of changing the display mode of the blocks 7 gradually with the progress of the game.

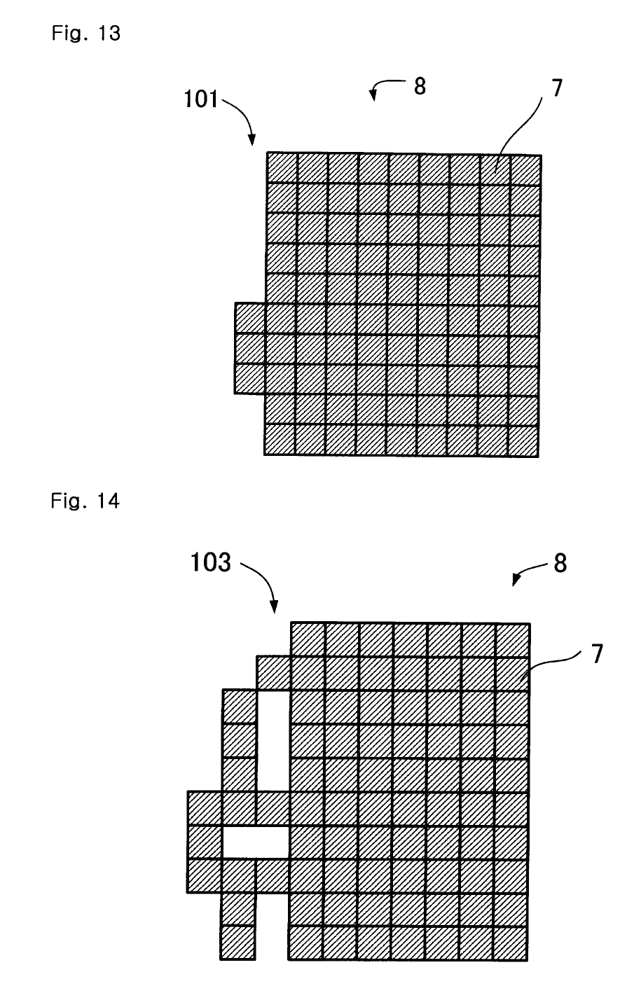

Further, another example is described. FIGS. 13 to 17 show how the blocks 7 are gradually brought into a non-displayed state after the game is started. In the FIGS. 13 to 17, only for the convenience of explanation, the existing blocks are shaded, but the way that the blocks are actually displayed on the lower display 6 is the same as in FIG. 1.

The internal lottery processing is performed to determine the content of the prize. Then, some blocks at predetermined positions where the shape of the prize does not have any blocks in the matrix of 10×10 displayed on the lower display 6 gradually are brought into a non-displayed state as mentioned before. In this example, those blocks are gradually brought into a non-displayed state from left side. More specifically, in FIG. 13, the blocks in the leftmost column 101 are brought into the non-displayed state if they are not necessary to form the shape of the prize. In FIG. 14, the blocks in the three columns from the third column 103 are brought into the non-displayed state if they are not necessary to form the shape of the prize.

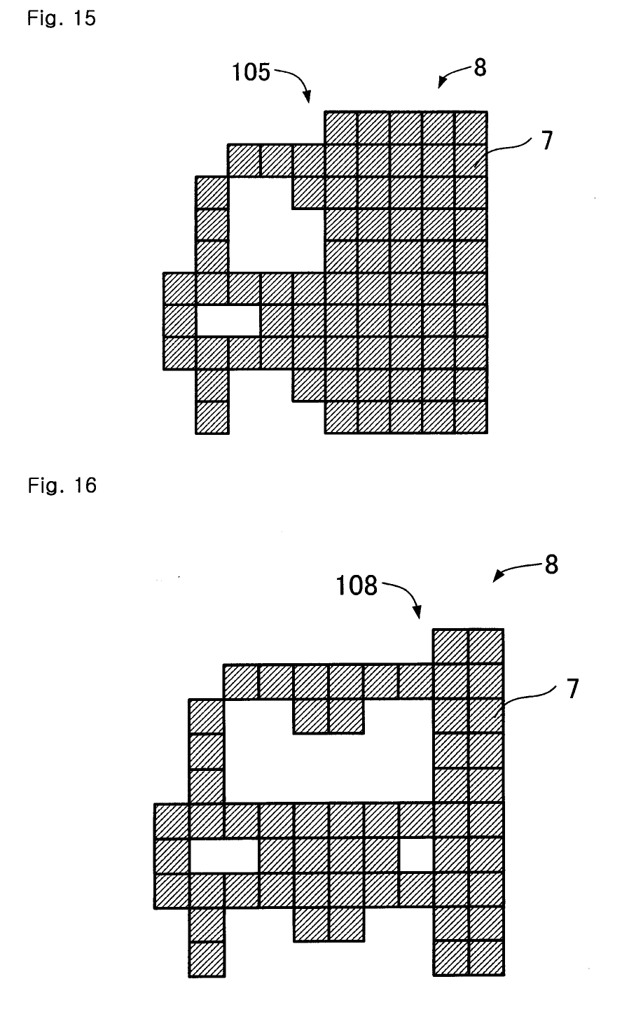

In FIG. 15, the blocks in the five columns from the fifth column 105 are brought into the non-displayed state such that the left half of the shape of the prize can be seen. Therefore, the game player may expect to win some prize. In FIG. 16, the blocks in the five columns from the eighth column 108 are brought into the non-displayed state such that almost all of the shape of the prize can be seen. Then, the game player finds what is won as the game player see the image and caption on the lower display 6.

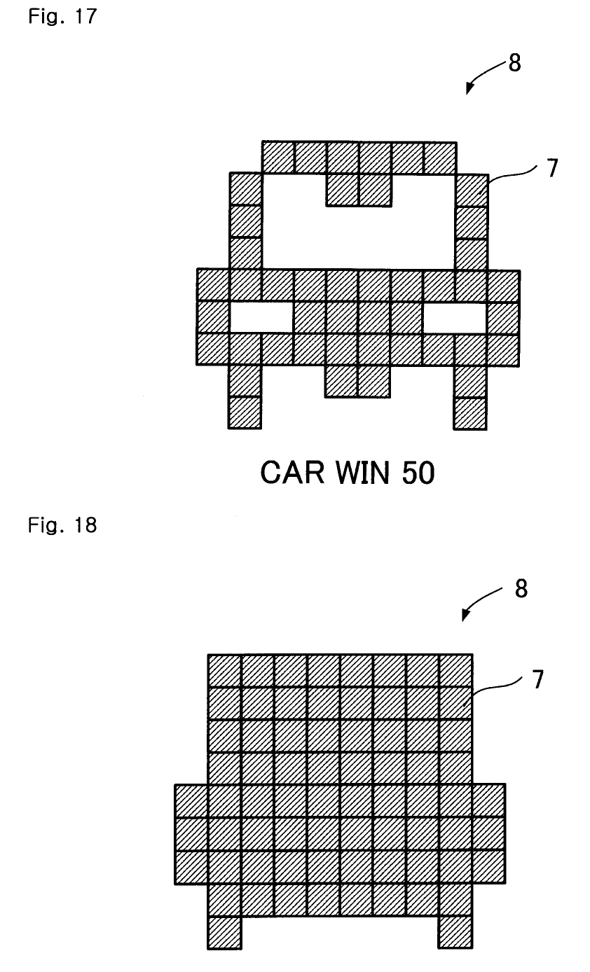

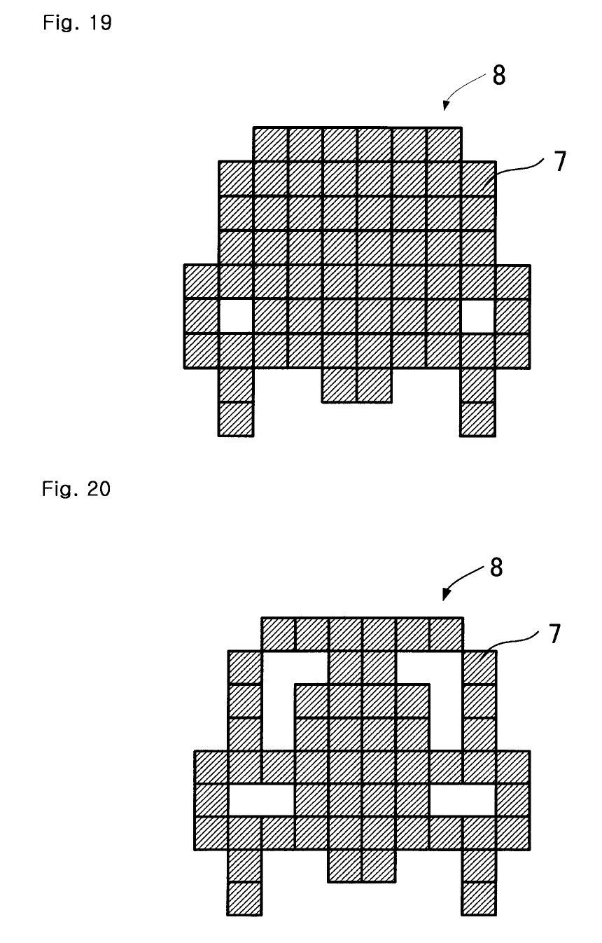

From FIGS. 18 to 20 show still another example of the way the blocks 7 are gradually brought into a non-displayed state after the game is started. Likewise, the existing blocks are shaded in the figures. In this example, blocks 7 positioned at an outer shell are brought into the non-displayed state if they are not necessary to form the shape of the prize. In FIG. 18, the outmost blocks are brought into the non-displayed state. And in FIG. 19, the blocks on the second shell are brought into the non-displayed state such that the game player may find head light portions, which look like eyes. In FIG. 20, the displayed image is further developed, but it is still unclear what will appear after all so as to maintain the game player's interest in the content of the prize. Then, the image turns out to be the vehicle as shown in FIG. 17.

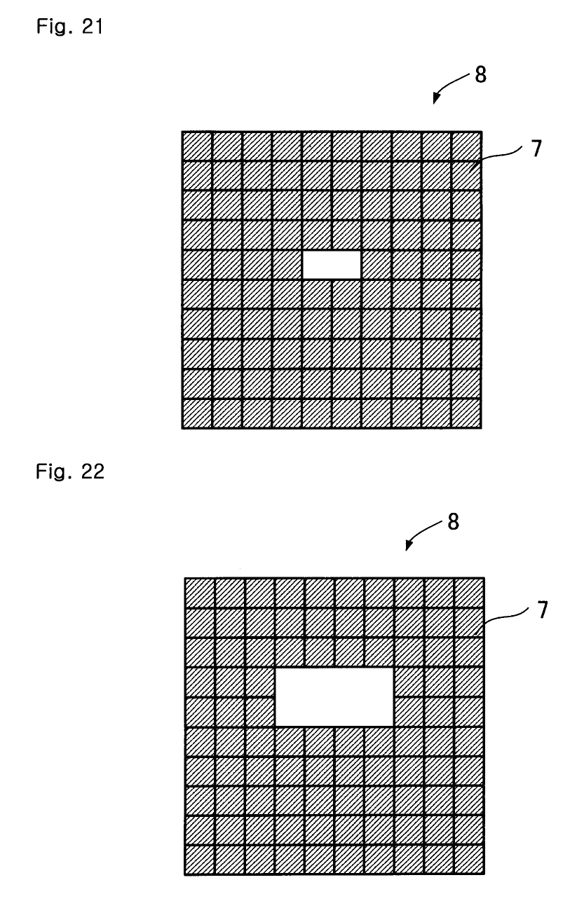

From FIGS. 21 to 24 show yet another example of the way the blocks 7 are gradually brought into a non-displayed state after the game is started. Likewise, the existing blocks are shaded in the figures. In this example, blocks 7 positioned at the center portion are brought into the non-displayed state first if they are not necessary to form the shape of the prize.

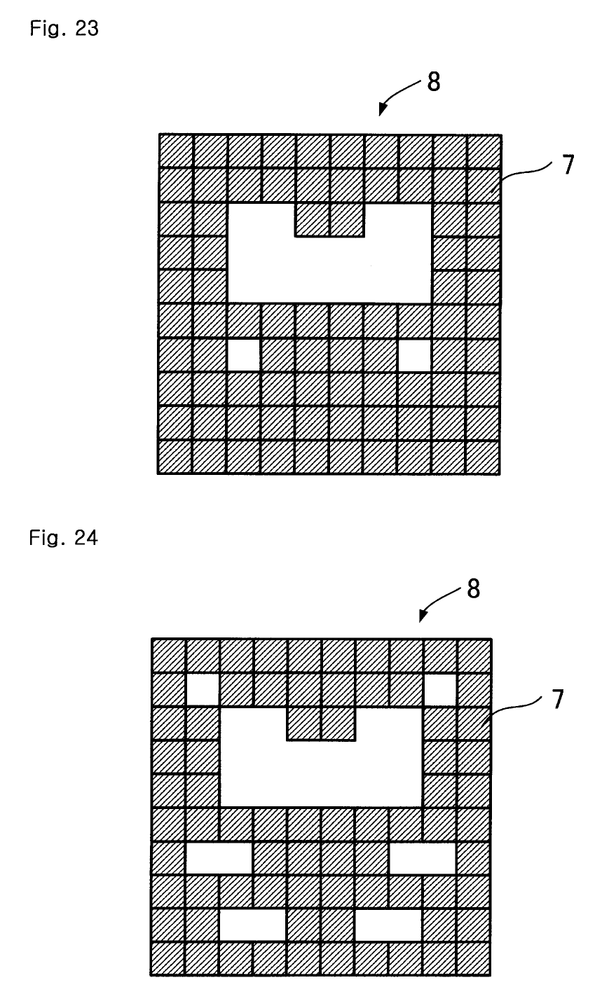

In FIG. 21, the four blocks 7 in the center portion are subject to this non-displayed state conversion. However, the lower two are required to form the shape of the prize so as to see only two blocks are brought into the non-displayed state. But, it is not easy for the game player to predict the shape at this point. In FIG. 22, the sixteen blocks 7 in the center portion are subject to this non-displayed state conversion and eight of them are brought into the non-displayed state. In FIG. 23, the thirty six blocks 7 in the center portion are subject to this non-displayed state conversion and eighteen of them are brought into the non-displayed state. Now, the headlight portions are partially opened. In FIG. 24, sixty four blocks 7 in the center portion are subject to this non-displayed state conversion and eighteen of them are brought into the non-displayed state. Now, only the blocks on the outmost shell are not subject to this non-displayed state conversion. However, it is not easy to predict the shape since the contour of the vehicle is important to recognize the whole shape. Then, the shape turns out to be the vehicle as shown in FIG. 17.

As explained above, the way the shape of the prize is displayed causes various effects on the recognition of the shape by the game player. Therefore, it is possible to change the way according to the shape of the prize so as to achieve preferable effects.

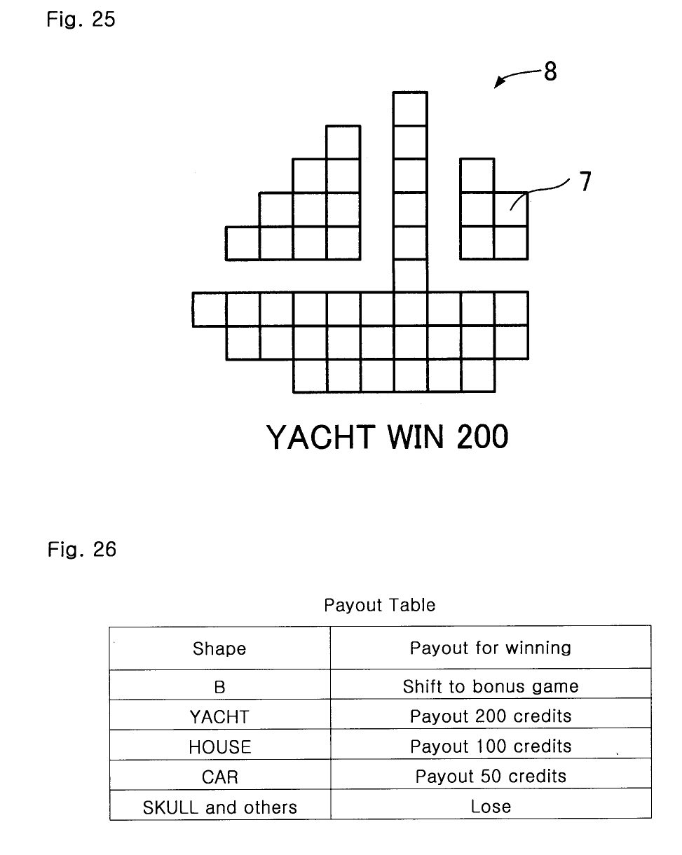

FIG. 25 shows another example of the prizes. It is a yacht prize to win 200 credits as shown in a payout table of FIG. 26. In the game machine 1, the prizes can be mutually related such that the game player can enjoy a kind of story. For example, some player may think that he would like to get the vehicle prize firstly, the house prize secondly, and then the yacht prize such that the player can enjoy driving a car to move in somewhere and building a house to settle. Then, the player can enjoy cruising a yacht. Such kind of story may be displayed on the upper display 5 as the player get the prizes.

Further, a gaming machine and a method of playing a game in the gaming machine as described below may be provided in accordance with the present invention.

Here, a gaming machine (e.g., gaming machine 1) may comprise: a display (e.g., lower display 6) for displaying blocks (e.g., block 7) in a predetermined shape and a controller (e.g., controller 49) for providing a prize when a arrangement shape formed by a combination of blocks displayed on the display matches a predetermined arrangement shape. The gaming machine is characterized in that the plurality of blocks are displayed in a matrix of M by N (here, M and N are natural numbers) on the display and that a display mode of blocks located at predetermined positions among the plurality of blocks displayed on the display is changed during a process until an end of a game.

The gaming machine (e.g., gaming machine 1) may also comprise: a display (e.g., lower display 6) for displaying blocks (e.g., block 7) in a predetermined shape and a controller (e.g., controller 49) for providing a prize when an arrangement shape formed by a combination of blocks displayed on the display matches a predetermined arrangement shape. The gaming machine is characterized in that the plurality of blocks are displayed in a matrix of M by N (here, M and N are natural numbers) on the display and that some blocks located at predetermined positions among the plurality of blocks displayed on the display are changed from in a displayed state to in a non-displayed state during a process until an end of a game such that the arrangement shape is formed by the combination of blocks due to the state change.

The gaming machine (e.g., gaming machine 1) may also comprise: a display (e.g., lower display 6) for displaying blocks (e.g., block 7) in a predetermined shape and a controller (e.g., controller 49) for providing a prize when an arrangement shape formed by a combination of blocks displayed on the display matches a predetermined arrangement shape which suggests a content of the prize. The gaming machine is characterized in that the plurality of blocks are displayed in a matrix of M by N (here, M and N are natural numbers) on the display and that some blocks located at predetermined positions among the plurality of blocks displayed on the display are changed from in a displayed state to in a non-displayed state during a process until an end of a game such that the arrangement shape is formed by the combination of blocks due to the state change.

The above-mentioned gaming machine (e.g., gaming machine 1) is also characterized in that the prize is provided when an arrangement shape formed by a combination of blocks (e.g., block 7) displayed on the display matches a predetermined arrangement shape which suggests a content of the prize.

The above-mentioned gaming machine (e.g., gaming machine 1) is also characterized in that a display color of some blocks located at predetermined positions among the plurality of blocks displayed on the display is changed during a process until the end of the game.

A method of playing a game with a gaming machine (e.g., gaming machine 1) is provided. The method comprises the steps of: displaying blocks (e.g., block 7) in a matrix of M by N (here, M and N are natural numbers) on a display (e.g., lower display 6); changing a display mode of blocks located at predetermined positions among the blocks in the matrix displayed on the display during a process until the game ends; and providing a prize when an arrangement shape formed by a combination of blocks matches a predetermined arrangement shape.

The method of playing the game with the gaming machine (e.g., gaming machine 1) comprises the steps of: displaying blocks (e.g., block 7) in a matrix of M by N (here, M and N are natural numbers) on a display (e.g., lower display 6); making some blocks located at predetermined positions in a non-displayed state among the blocks in the matrix displayed on the display during a process until the game ends; and providing a prize when an arrangement shape formed by a combination of blocks matches a predetermined arrangement shape.

The method of playing the game with the gaming machine (e.g., gaming machine 1) comprises the steps of: displaying blocks (e.g., block 7) in a matrix of M by N (here, M and N are natural numbers) on a display (e.g., lower display 6); making some blocks located at predetermined positions in a non-displayed state among the blocks in the matrix displayed on the display during a process until the game ends; and providing a prize when an arrangement shape formed by a combination of blocks matches a predetermined arrangement shape which suggests a content of the prize.

The method of playing the game with the gaming machine (e.g., gaming machine 1) is characterized in that the prize is provided when an arrangement shape formed by a combination of blocks matches a predetermined arrangement shape which suggests a content of the prize.

The method of playing the game with the gaming machine is characterized in that that a display color of some blocks located at predetermined positions among the plurality of blocks displayed on the display is changed during a process until the end of the game.

In the gaming machine or the method of playing the game with the gaming machine according to the present invention, a display mode of some blocks displayed at predetermined positions among the displayed blocks is changed during processing until the end of the game and the prize is provided when the arrangement shape formed by the combination of blocks displayed on the display matches a predetermined arrangement shape such that the content of the prize may be notified by the changing arrangement shape gradually formed by the combination of blocks as the game progresses. Thus, it is possible to provide a new type of game without relying on the displayed symbols. The variation of the notification may also be wider so as not to bore the game player.

Also, since the prize is provided when the arrangement shape formed by the combination of blocks matches the predetermined arrangement shape which suggests a content of the prize, it is possible for the game player to judge easily whether the prize is won or not by looking at the arrangement shape of the blocks at a glance. It is also possible to improve the expectation of the game player toward the arrangement shape change of the blocks.

Also, since the display color of the blocks provided at predetermined positions during the processing until the game ends, it is possible to recognize the arrangement shape formed by the combination of blocks more clearly.

Therefore, in the conventional gaming machine, it is common to provide symbols in predetermined areas to be displayed variably and statically even though many kinds of determination methods to judge whether the prize is won or not. Therefore, the game may become monotonous after the game is played for a long period of time and it is difficult to recognize the content of the prize at a glance of the array of symbols. However, this may not apply to the present invention.

What is claimed is:

1. A gaming machine comprising:
a display for displaying a plurality of blocks appearing in a predetermined shape; and
a controller for providing a prize when an arrangement shape formed by a combination of blocks displayed on the display matches a predetermined arrangement shape,
wherein:
the plurality of blocks are displayed in a matrix of M by N (here, M and N are natural numbers) on the display; and
a display mode of blocks located at predetermined positions among the plurality of blocks displayed on the display is changed during a process until an end of a game.

2. The gaming machine according to claim 1, wherein the display mode of the blocks is changed from a displayed state to a non-displayed state.

3. The gaming machine according to claim 1, wherein the predetermined arrangement shape is capable of suggesting a content of the prize.

4. The gaming machine according to claim 2, wherein the predetermined arrangement shape is capable of suggesting a content of the prize.

5. The gaming machine according to claim 1, wherein the display mode of the blocks is changed from in an original display color to a changed display color.

6. The gaming machine according to claim 1, wherein the display mode of the blocks is gradually changed in the matrix by a predetermined way corresponding to the predetermined arrangement shape.

7. The gaming machine according to claim 1, wherein the display mode of the blocks is gradually changed in the matrix from a leftmost column.

8. A method of playing a game with a gaming machine comprising the steps of:
displaying blocks in a matrix of M by N (here, M and N are natural numbers) in a display;
changing a display mode of blocks located at predetermined positions among the blocks in the matrix displayed on the display during a process until the game ends;
providing a prize when an arrangement shape formed by a combination of blocks matches a predetermined arrangement shape.

9. The method according to claim 8, wherein the display mode of blocks located at predetermined positions is changed from a displayed state to a non-displayed state.

10. The method according to claim 8, wherein the predetermined arrangement shape is capable of suggesting a content of the prize.

11. The method according to claim 9, wherein the predetermined arrangement shape is capable of suggesting a content of the prize.

12. The method according to claim 8, wherein the display mode of the blocks is changed from in an original display color to a changed display color.

13. The method according to claim 8, wherein the display mode of the blocks located at the predetermined positions is gradually changed in the matrix by a predetermined way corresponding to the predetermined arrangement shape.

14. The gaming machine according to claim 8, wherein the display mode of the blocks located at the predetermined positions is gradually changed in the matrix from a leftmost column.
